(19) United States
(12) Patent Application Publication
(10) Pub. No.: US 2026/0357645 A1
(43) Pub. Date: Nov. 12, 2026

(54) Method and Apparatus for Applying Slit Spacer to Edge of Pane

(71) Applicant: Quanex IG Systems, Inc., Cambridge, OH (US)

(72) Inventors: William M. Parks, Fresno, OH (US); John R. Ryba, Swansboro, NC (US); Mark Christopher Molinaro, Leo, IN (US); Joe B. Erb, Gnadenhutten, OH (US); Kenneth F. Wayman, Port Washington, OH (US); John DeVecka, Dover, OH (US)

(21) Appl. No.: 19/120,948

(22) PCT Filed: Oct. 16, 2023
(86) PCT No.: PCT/US2023/076978

§ 371 Date: Apr. 14, 2025

Related U.S. Application Data
(60) Provisional application No. 63/416,385, filed on Oct. 14, 2022.

(51) Int. Cl. E06B 3/673

(52) U.S. Cl. CPC E06B 3/67326

(57) ABSTRACT

A method of applying a slit spacer to the edge of the pane includes the steps of opening the slit of the spacer to define an open channel before the spacer is brought into contact with the edge of the pane, locating the edge of the pane within the open channel, and then allowing the spacer to resiliently close onto the edge of the pane. This avoids primarily using the edge of the pane to force open the slit of the spacer. When the pane is thin glass, the panel can break when its edge is used to open the spacer channel; especially when the spacer is applied at relatively high speeds. Having the slit of the spacer opened into an open channel wide enough to avoid or minimize contact between the edge of the panel and the inner surface of the spacer reduces the forces experienced by the panel during the installation of the panel.

### BACKGROUND OF THE DISCLOSURE

### 1. Technical Field

The disclosure relates to methods and apparatus for applying a spacer to the edge of a pane. More particularly, the disclosure relates to methods and apparatus for applying a flexible, slit spacer to the edge of a center pane used for a triple-sheet insulating glass units.

### 2. Background Information

Multiple-pane insulating units are used to increase the energy efficiency of houses and other buildings. A multiple-pane insulating unit includes a pair of outer glazing panes spaced apart by a spacer disposed about or just inside the perimeter of the panes. The two panes cooperate with the spacer to form an insulating sealed cavity that is either filled with air or an inert gas. One or more inner panes can be held by the spacer assembly in a substantially parallel relation to the outer glazing panes. The inner pane or panes can be another pane of glass having the same thickness as the outer panes, another pane of glass that is thinner than the outer panes, or a thin flexible plastic inner film that is typically made from polyethylene terephthalate (PET). In a triple unit, the inner pane divides the single cavity into a pair of cavities to add a further layer of insulation between the outside atmosphere and the inside atmosphere. One method of forming a triple-pane insulating unit is to use two spacers between the three panes to form side-by-side individually-sealed insulating cavities. Examples of this configuration are described in FIGS. 4-7 of U.S. Pat. No. 4,831,799. Another method of forming triple-pane insulating units is disclosed in WO 2021/055447 A1 which includes a slit spacer 10 shown in FIGS. 1 and 2 of this application. In FIG. 1, a triple pane insulating unit 2 includes first 4 and second 6 outer panes and an inner third pane 8 supported by a perimeter spacer assembly 10. Panes 4, 6, and 8 can be glass or other materials such as transparent or semi-transparent polymer panes. The combination of outer panes 4 and 6 with spacer assembly 10 define an inner insulating chamber that can be filled with air or an inert gas. Inner third pane 8 can be provided substantially thinner (0.5 mm to 2.0 mm such as 0.7 mm for example) than panes 4 and 6 so that the thickness and weight of unit 2 is the same as or not much larger than a traditional double unit. First and second panes 4 and 6 can be provided in thicknesses of from 2 mm to 10 mm with exemplary thicknesses being from 3 mm to 4 mm and 9 mm to 10 mm.

Spacer assembly 10 includes a spacer body 20 that is made from a solid or foamed resilient material such as rubber, silicone, or EPDM. The material can be permeable to moisture-vapor or impermeable. When the material is permeable, a desiccant can be disposed throughout spacer body 20. Depending on the moisture and gas permeability of the material used behind spacer assembly 10, spacer assembly 10 may include a vapor and gas barrier 22 applied to the outer surface 24 of spacer body 20. This barrier 22 may be a coating applied directly to spacer body 20 or as separate sheet 22 adhered to spacer body 20. Vapor barrier 22 may be a metal foil, plastic sheet, or metalized plastic film.

The flexible or semi-rigid foam spacer body 20 can be manufactured from thermoplastic or thermosetting plastics. Suitable thermosetting plastics include silicone and polyurethane. Suitable thermoplastic materials include thermoplastic elastomers such as Santoprene. Foamed silicone can be used. The advantages of the silicone foam include: good durability, minimal outgassing, low compression set, good resilience, high temperature stability and cold temperature flexibility. A further advantage of the silicone foam is that the material is moisture permeable and so moisture vapor can easily reach the desiccant material within the foam.

During the production of the foam, desiccant is added as a fill. The type of desiccant material used is typically 3 A molecular sieve zeolites to remove moisture vapor and in addition smaller amounts of 13× molecular sieves, silica gel or activated carbon are used to remove organic vapors. Overall, the amount of desiccant material to be used should match the amount of desiccant material that is typically incorporated in a conventional sealed glazing unit.

The inner surface 34 of spacer body 20 must be UV resistant so that the material does not dust or flake after prolonged exposure to sunlight. To provide the necessary long term durability and depending on the material used, various specialized measures may be taken including adding UV stabilizers to the material and covering or coating the inner surface 34 of the spacer body 20. For durable plastic materials such as silicone, because of their excellent UV resistance, there is no need to specially coat or cover the inner face.

Adhesive 26 connects spacer body 20 to the inner surfaces of panes 4 and 6. The adhesive can be a pressure sensitive acrylic adhesive. Pressure sensitive adhesive 26 is preapplied to opposite sides of spacer body 20. In selecting a suitable adhesive, there are five main criteria: high tack, shear strength, heat resistance, UV resistance, and non-outgassing. For the silicone foam spacer body although various adhesives can be used, the adhesive can be a UV resistant pressure sensitive acrylic adhesive.

Spacer assembly 10 is backed with a sealant 28. Sealant 28 can be a polyisobutalene-based sealant. Sealant 28 is disposed in a channel defined outwardly of spacer assembly 10 between first 4 and second 6 panes.

Spacer body 20 defines a channel that resiliently holds the outer edge portion of inner third pane 8. The channel include an open channel base 30 with a channel neck 32 that connects channel base 30 to inner surface 34 of spacer body 20. The center of channel base 30 is offset inwardly (reference dimension 40 in FIG. 2) within spacer body 20 from the centerline of spacer body 20. Before inner third pane 8 is placed into channel base 30, channel neck 32 has a width that is smaller than the thickness of inner pane 8 such that the shoulder portions 36 of spacer body 20 that define channel neck 32 resiliently engage inner third pane 8 to provide a compressive force. Shoulder portions 36 are disposed inwardly of channel base 30, outward of channel neck 32, and outward of inner surface 34. When closed back on inner third pane 8 shoulder portions 36 provide a closed, smooth appearance to inner surface 34. Inner surface 34 is visible so providing a closed, smooth appearance is a desirable feature to spacer body 20.

The art desires methods and apparatus for applying spacers similar to spacer 10 to the edge of pane 8 while minimizing the chance of breaking pane 8.

### SUMMARY OF THE DISCLOSURE

The disclosure provides methods and apparatus for applying a slit spacer to the edge of the pane. The methods include the steps of opening the slit of the spacer to define an open channel before the spacer is brought into contact with the edge of the pane and then allowing the spacer to close onto the edge of the pane. This avoids primarily using the edge of the pane to force open the slit of the spacer. When the pane is thin glass, the panel can break when its edge is used to open the spacer channel; especially when the spacer is applied at relatively high speeds. Having the slit of the spacer opened into an open channel wide enough to avoid or minimize contact between the edge of the panel and the inner surface of the spacer reduces the forces experienced by the panel during the installation of the panel.

The disclosure provides methods and apparatus that deform the portion of a slit spacer being applied to the edge of the pane to open the slit into an open channel that receives the edge of the pane. The open channel is then allowed to close onto the pane.

In one configuration, the disclosure provides a method and apparatus that bends the slit spacer to form an open channel. The outer surface of the spacer engages a bending device such as a roller or curved surface to bend the spacer in a direction away from the slit inner surface to open the slit into an open channel. The spacer is bent about an axis perpendicular to the longitudinal direction or length dimension of the spacer. With the slit open to define the open channel, the spacer is positioned over the edge of the pane. The spacer then resiliently closes onto the edge of the pane as it moves away from the bending device.

In another configuration, the disclosure provides a method and apparatus that deforms the spacer to open the slit spacer to form an open channel. As the spacer moves through the applicator head, the center portion of the outer surface is brought into contact with a bending device such as a wheel, bearing, or knob that pushes the center of the spacer in a direction toward the inner surface (or slit surface) while the edges of the spacer are held in place thus opening the slit into an open channel. The spacer is bent about an axis parallel with the longitudinal direction or length dimension of the spacer. With the slit open to define the open channel, the spacer is positioned over the edge of the pane. The spacer then resiliently closes onto the edge of the pane as it moves away from the bending device.

The disclosure provides methods that are performed by hand or with semi-automated or automated equipment. The disclosure provides apparatus that are incorporated into hand-operated spacer application tools or semi-automated or automated application heads.

The individual features described herein may be combined in different combinations than specifically described below to form different configurations of the device of the disclosure. The preceding non-limiting aspects of the disclosure, as well as others, are more particularly described below. A more complete understanding of the devices, assemblies, and methods can be obtained by reference to the accompanying drawings, which are not intended to indicate relative size and dimensions of the assemblies. In those drawings and the description below, like numeric designations refer to components of like function. Specific terms used in that description are intended to refer only to the particular structure of the embodiments selected for illustration in the drawings, and are not intended to define or limit the scope of the disclosure.

### BRIEF DESCRIPTION OF THE DRAWINGS

FIG. 1 is a section view of a prior art triple-pane insulating glass unit with the middle portion broken away.

FIG. 2 is a section view of a prior art exemplary spacer body.

FIG. 3 is an end view of a first configuration of a spacer applicator device showing a slit spacer bent to form an open channel receiving the edge of the pane.

FIG. 4 is a side view of the spacer applicator device of FIG. 3 without the pane and more of the spacer depicted to show the open channel closing.

FIG. 5 is a side view of a second configuration of a spacer applicator device.

FIG. 6 is an end view of the spacer applicator device of FIG. 5.

FIG. 7 is an enlarged end plan view depicting the portion of the spacer of FIG. 3 engaging the edge of the pane.

FIG. 8 is a top plan view of FIG. 7.

FIG. 9 is an enlarged end view depicting the portion of the spacer of FIG. 6 engaging the edge of the pane.

FIG. 10 is a top plan view of FIG. 9.

FIG. 11 depicts exemplary slit spacer cross sections.

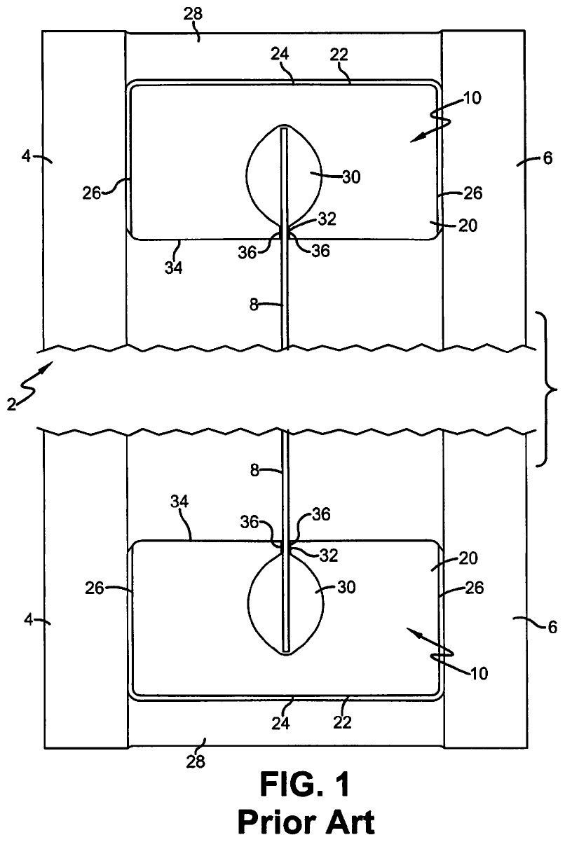

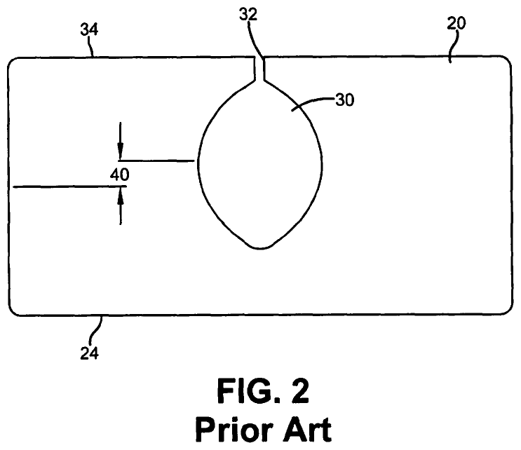

### DETAILED DESCRIPTION OF THE DISCLOSURE

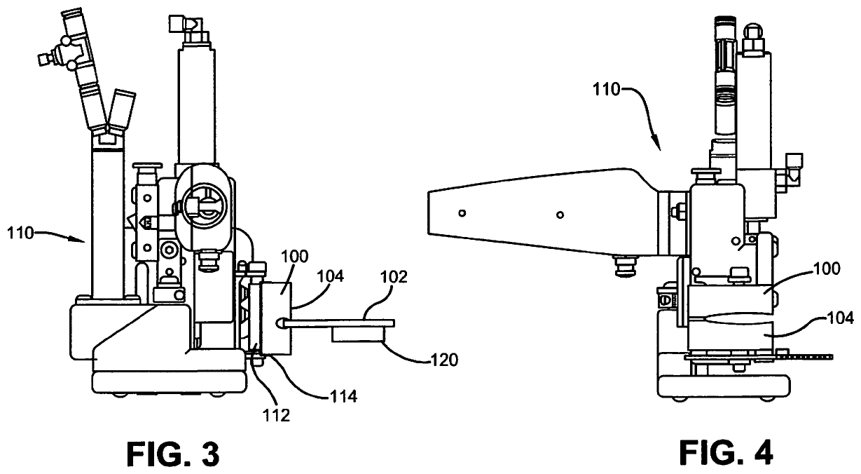

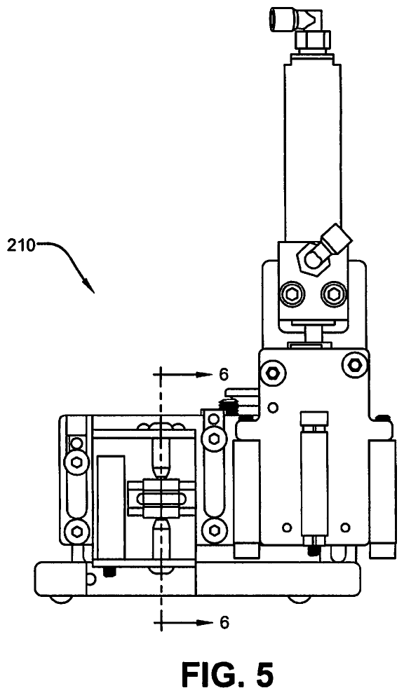

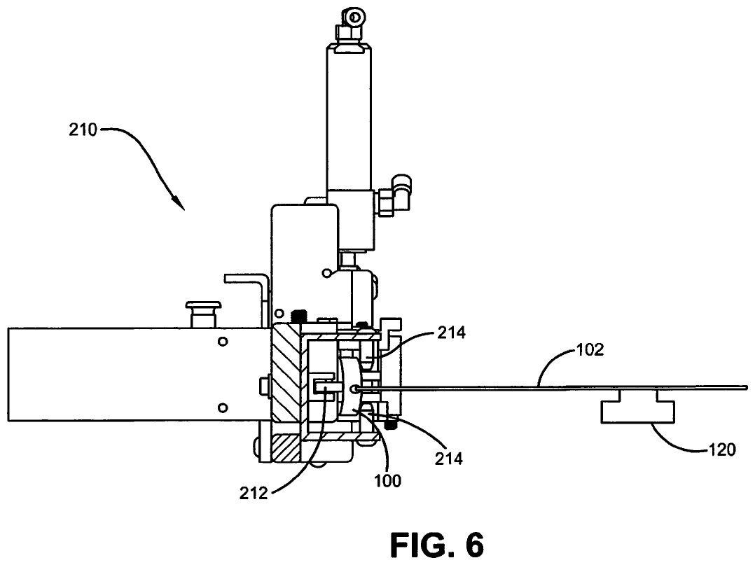

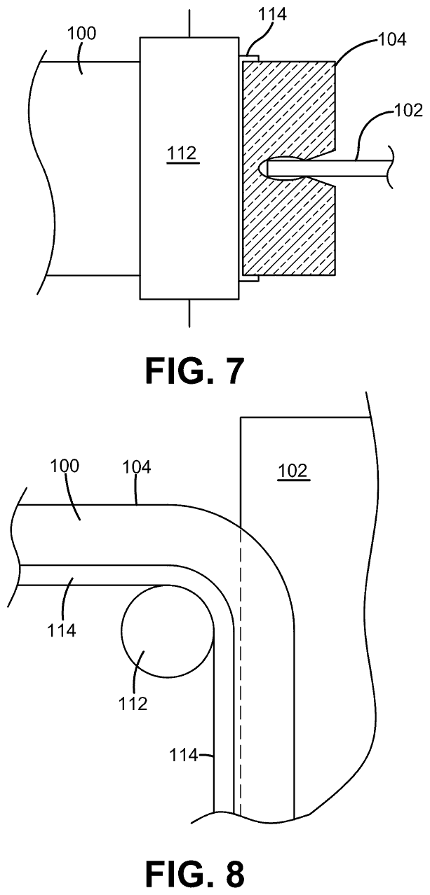

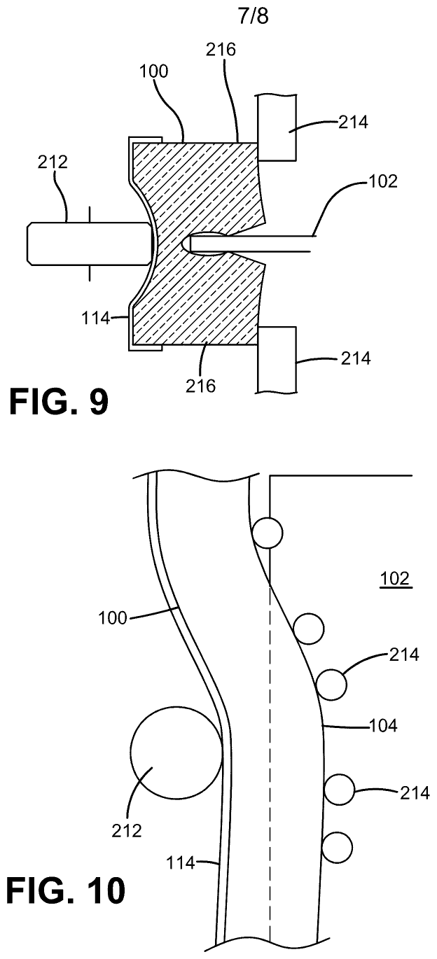

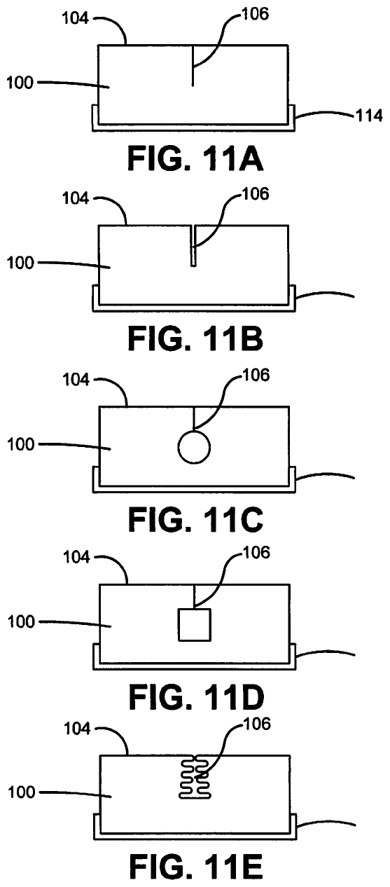

First embodiments of the method and apparatus of the disclosure are depicted in FIGS. 3, 4, 7, and 8. Second embodiments of the method and apparatus of the disclosure are depicted in FIGS. 5, 6, 9, and 10. The embodiments provide methods and apparatus for applying a slit spacer 100 to the edge of a pane 102 such as the thin glass pane depicted in the drawings. Spacer 100 can have the structure of spacer 10 described in the Background or a spacer structure wherein the inner surface 104 of spacer 100 is slit to receive the edge of pane 102. Exemplary spacer configurations are depicted in FIG. 11 with slits 106 that can be opened by the methods and apparatus described herein. The bodies of the spacers depicted in FIG. 11 are flexible, resilient bodies such as that described in the Background section above.

In the first embodiments, spacer 100 is bent about an axis perpendicular to the length of spacer 100 to open the slit into an open channel that receives the edge of the pane 102. As shown in FIG. 8, spacer 100 is brought into applicator device 110 in a direction perpendicular to the edge of pane 102. Applicator device 110 has guides that align spacer 100 and hold it square as it moves relative to device 110. Spacer 100 is brought into engagement with a bending device 112 and turned to a position that opens the spacer slit. In one exemplary configuration, spacer 100 is turned at least ninety degrees to be parallel with the edge of pane 102. In other configurations, the spacer can be oriented less than perpendicular to the edge of pane 102 and redirected less than ninety degrees as long as the bend is sufficient to open the configuration of the slit defined by the spacer. The spacer thickness and slit configuration determines the amount of bending required to open the slit. Bending device 112 is one of a roller or a fixed curved surface. The height of bending device 112 is larger than the width of spacer 100. Bending device 112 is smooth and has a radius large enough that the vapor barrier 114 on the outer surface of spacer 100 is not damaged as it engages bending device 112. The radius also must be small enough to bend spacer 100 enough to open slit 106 enough to allow the edge of pane 102 to be received within the open slit. A bending device having a radius of 4.76 mm (three-sixteenths of an inch) has been found to bend the spacer body having a thickness (between inner and outer surfaces) of about 6 mm (about 0.25 inches) to about 13 mm (about 0.50 inches) sharply enough to open the slit while not damaging the vapor barrier 114. The action of moving the spacer around the device 112 opens the middle of the spacer allowing it to be placed over the edge of the pane. This continues as the applicator's installation head is moved around the perimeter of the pane. Just before being brought into engage with the edge of pane 102, the slit of the spacer is opened to receive the pane edge without using the edge of pane 102 to force its way into the spacer. The spacer slit is open enough to prevent the end wall of pane 102 from engaging inner surface 104 of spacer 100. The movement is relative. The applicator can be moved with the pane fixed, the pane can move with the applicator being fixed, or a combination of both can be used.

The portion of spacer 100 engaged with bending device 112 and portions before device 112 and after device 112 has its slit open to form an open channel as shown in FIG. 4. The portion of spacer 100 having the open channel is moved onto the edge of pane 102. As bending device 112 moves away from the portion with the open channel, the material of spacer relaxes and closes onto pane 102 to install spacer 100 onto pane 102.

In the second embodiments, the spacer 100 is bent about an axis that is parallel to the length of the spacer. In these embodiments, in cross section, the rectangular cross section of the spacer is bent into a gentle “C” shape by a bending device 212 that engages the middle of the outer spacer surface opposite the slit location while the top and bottom inner corners 216 are held by guide supports 214. Two guide supports 214 are depicted in the exemplary configuration shown in the drawings. Guide supports 214 can be aligned with bending device 212 or guide supports 214 can be positioned upstream and downstream of the location of bending device 212. As above, bending device 212 can be a roller or bearing that rotates or a fixed curved surface. As spacer 100 passes over bending device 212, the middle portion of spacer 100 is forced outwardly toward pane 102 and the slit is opened to form an open channel. The edge of pane 102 is positioned in the open channel and the space is then allowed to close back down onto the edge of pane 102. As above, the movement is relative. The applicator can be moved with the pane fixed, the pane can move with the applicator being fixed, or a combination of both can be used.

Applicator devices 110 and 210 include cutting devices for cutting the entire body of spacer 100 after it has been installed about the entire perimeter of pane 102. Applicator devices 110 and 210 also include notching devices for notching the inner surface of spacer 100 to form corners. Both devices 110 and 210 can be manually-operated applicators, semi-automated applicators, or fully automated applicators. When a manually-operated applicator is used, pane 102 is carried on a selectively rotating platform 120 (such as a vacuum table) that holds pane 102 in place during the application. Automated applicators travel around the perimeter of pane 102. Alternatively, automation could be the use of “cart wheeling” where the applicator is stationary and the glass is brought to the head and moved to install. Such a cart-wheel style method also can be performed with a manual installation method. Multiple applicators 110 and 210 may be used along different sides of pane 102. Both embodiments allow the spacer 100 to be rapidly applied to pane 102 while reducing the risk of breakage to a thin pane 102.

In the foregoing description, certain terms have been used for brevity, clearness, and understanding. No unnecessary limitations are to be implied therefrom beyond the requirement of the prior art because such terms are used for descriptive purposes and are intended to be broadly construed. Moreover, the above description and attached illustrations are an example and the invention is not limited to the exact details shown or described. Throughout the description and claims of this specification the words “comprise” and “include” as well as variations of those words, such as “comprises,” “includes,” “comprising,” and “including” are not intended to exclude additives, components, integers, or steps.

1. A method of applying a flexible, resilient slit spacer to an edge of a thin pane comprising the steps of:
imparting a bending force to a first portion of a resilient slit spacer to change the slit from a closed configuration to an open configuration;
moving the spacer and thin pane relative to each other to locate a portion of the thin pane in the open slit; and
removing the bending force from the first portion of the slit spacer to allow the slit spacer to resiliently close from the open configuration to the closed configuration engaging the thin pane.

2. The method of claim 1, further comprising the step of changing the slit to its open configuration before the thin pane is in contact with the resilient slit spacer to minimize the contact between the thin pane and the spacer while the spacer is being applied to the thin pane.

3. The method of claim 1, wherein the step of imparting a bending force is performed by a bending device that is not a portion of the thin pane.

4. The method of claim 1, further comprising the step of bending the first portion of the slit spacer about an axis perpendicular to a longitudinal dimension of the slit spacer.

5. The method of claim 4, wherein the slit spacer has an outer surface and further comprising the step of turning the spacer over a bending device with the outer surface of the slit spacer engaging the bending device.

6. The method of claim 5, further comprising the step of bending the first portion of the slit spacer at least ninety degrees.

7. The method of claim 5, further comprising the step of rotating the bending device.

8. The method of claim 5, wherein the slit spacer has a moisture vapor barrier on its outer surface and further comprising the step of contacting the moisture vapor barrier with the bending device.

9. The method of claim 1, further comprising the step of bending the first portion of the slit spacer about an axis parallel to a longitudinal dimension of the slit spacer.

10. The method of claim 9, further comprising the step of imparting the bending force with a bending device that engages a center of an outer surface of the slit spacer while supporting both inner corners of the slit spacer.

11. The method of claim 10, further comprising the step of rotating the bending device as it engages the outer surface of the slit spacer.

12. The method of claim 11, wherein the slit spacer has a moisture vapor barrier on its outer surface and further comprising the step of contacting the moisture vapor barrier with the bending device.

13. A method of applying a slit spacer to an edge of a thin pane wherein the slit spacer has an inner surface opposite an outer surface and side surfaces with inner corners defined where each side surface joins the inner surface; the slit spacer defining a slit extending through the inner surface; the method comprising:
bending the slit spacer to open the slit so that it can receive the edge of the thin pane;
moving the edge of the thin pane and the open slit relative to one another until the edge of the pane is inside the open slit; and
allowing the slit to resiliently close on the edge of the thin pane to connect the slit spacer to the pane.

14. The method of claim 13, wherein the step of bending the slit spacer to open the slit occurs before the thin pane is in contact with the slit spacer to minimize the contact between the thin pane and the slit spacer while the spacer is being applied to the thin pane.

15. The method of claim 13, wherein the step of bending the slit spacer includes the step of bending a first portion of the slit spacer about an axis perpendicular to a longitudinal dimension of the slit spacer.

16. A method of applying a resilient slit spacer to an edge of a thin pane; the method comprising the steps of:
imparting a bending force to the slit spacer to open the slit before the spacer engages the thin pane;
after the slit is open, positioning an edge of the thin pane in the open slit; and
removing the bending force to allow the slit to resiliently close on the edge of the panel to connect the slit spacer to the pane.
